(19) United States
(12) Patent Application Publication
(10) Pub. No.: US 2016/0346917 A1
(43) Pub. Date: Dec. 1, 2016

(54) INTERACTIVE ROBOT RESPONDING TO HUMAN PHYSICAL TOUCHES IN MANNER OF BABY

(71) Applicant: HON HAI PRECISION INDUSTRY CO., LTD., New Taipei (TW)

(72) Inventors: CHANG-DA HO, New Taipei (TW); YI-CHENG LIN, New Taipei (TW); JEN-TSORNG CHANG, New Taipei (TW)

(21) Appl. No.: 14/815,051

(22) Filed: Jul. 31, 2015

(30) Foreign Application Priority Data
May 29, 2015 (CN) 201510285355.4

(51) Int. Cl. B25J 9/00; B25J 9/16

(52) U.S. Cl. CPC B25J 9/0003; B25J 9/1694; B25J 9/161

(57) ABSTRACT

An interactive robot mimicking a baby's reactions to physical touches by a human user includes a main portion and two hand portions at the sides. The main portion includes a display panel coupled to a signal processing module. The two hand portions include signal conducting poles and a triaxial force sensor. The signal conducting poles sense actions applied to the hand portions by the user and send signals to the triaxial force sensor. The triaxial force sensor converts the signals to an electrical signal. The signal processing module can determine the action applied by the user, determine an appropriate emotional reaction, and send a reaction signal to the display module. The display module displays a particular countenance after receiving the reaction signal.

### FIELD

The subject matter herein generally relates to robotics.

### BACKGROUND

An interactive robot may generate emotional reactions when different actions are applied to the robot by a user.

### BRIEF DESCRIPTION OF THE DRAWINGS

Implementations of the present technology will now be described, by way of example only, with reference to the attached figures.

FIG. 1 is a front view of one embodiment of an interactive robot.

FIG. 2 is a side view of one embodiment of the interactive robot of FIG. 1.

FIG. 3 is a front view of one embodiment of a hand portion of the interactive robot of FIG. 1.

FIG. 4 is a right view of one embodiment of the hand portion of the interactive robot of FIG. 1.

FIG. 5 is a diagrammatic view of one embodiment of a sensor array of the interactive robot of FIG. 1.

FIG. 6 is a block view of one embodiment of the interactive robot of FIG. 1.

FIG. 7 is a table showing a plurality of actions.

FIG. 8 is a table showing emotional reactions corresponding to the actions of FIG. 7.

FIG. 9 is similar to FIG. 7.

FIG. 10 is similar to FIG. 8.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

The present disclosure is described in relation to an interactive robot to generate emotional reactions when the robot is subjected to different actions by a user.

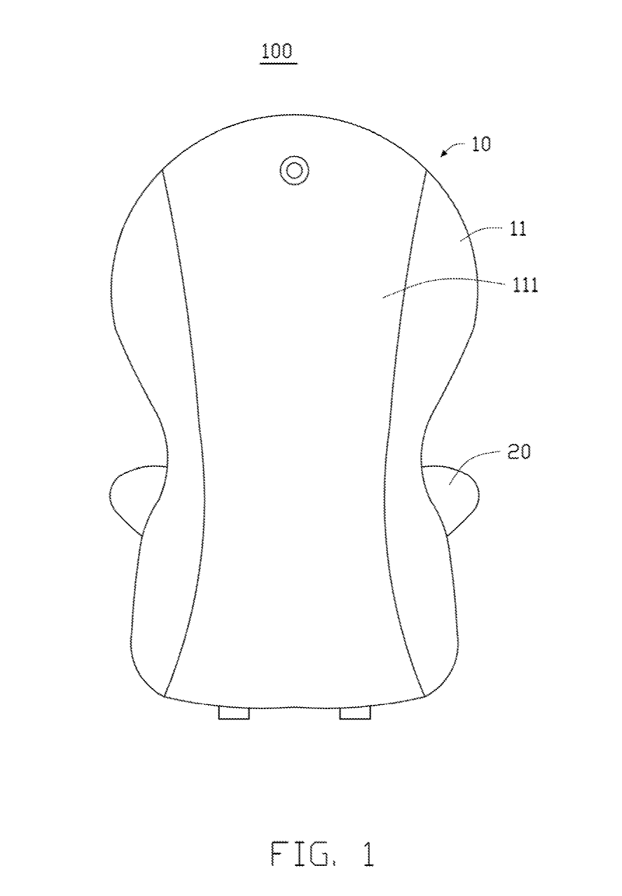

FIG. 1 illustrates an embodiment of an interactive robot 100. The interactive robot 100 has a wide awake, open, innocent appearance and is in a shape of baby. In at least one embodiment, a height of the interactive robot 100 is 650 millimeters (mm), a width of the interactive robot 100 is 400 mm.

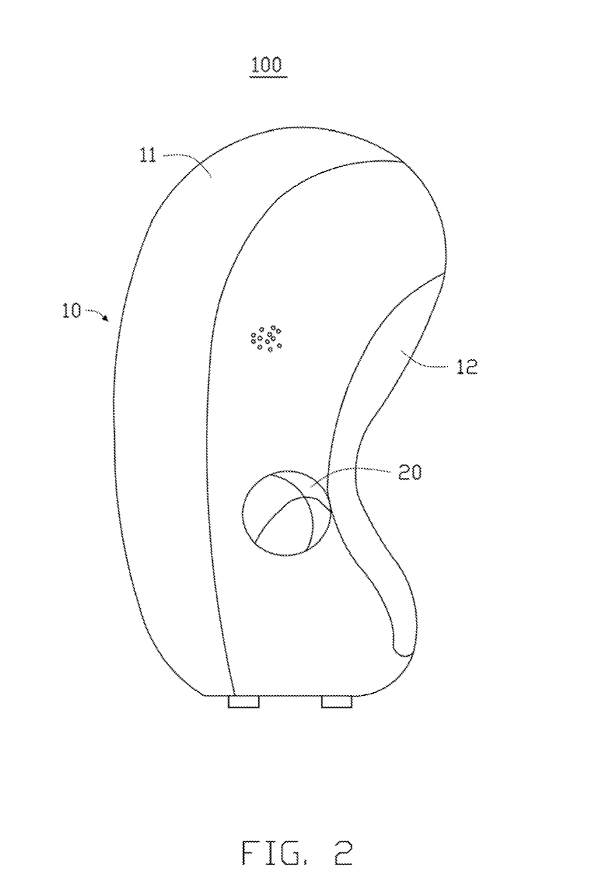

FIG. 2 illustrates that the interactive robot 100 comprises a main portion 10 and two hand portions 20 located at each side of the main portion 10. The main portion 10 comprises a front portion 11 and a back portion 12.

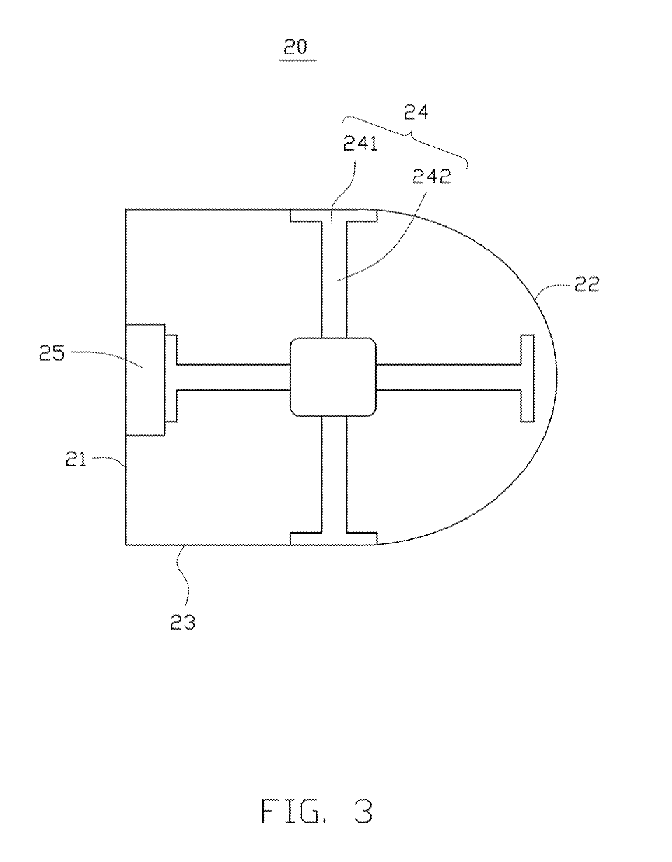

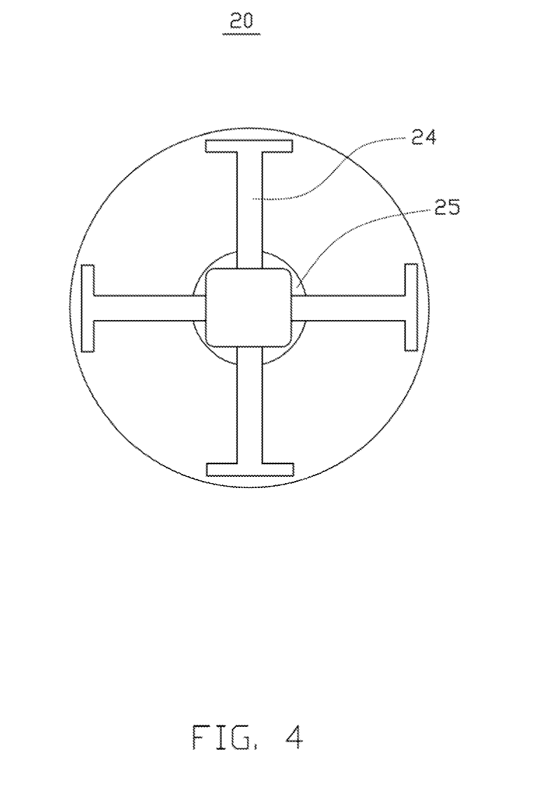

FIGS. 3 and 4 illustrate that each hand portion 20 may be made of silica gel or formaldehyde resin. Each hand portion 20 comprises a touching surface 21, a curved surface 22, and a connecting surface 23. The connecting surface 23 is coupled between the touching surface 21 and the curved surface 22. The hand portion 20 has a plurality of signal conducting poles 24 and a triaxial force sensor 25. The signal conducting poles 24 sense an action signal from the hand portion 20 and send the action signal to the triaxial force sensor 25. In at least one embodiment, each signal conducting pole 24 is substantially T-shaped, the touching surface 21 is a circular surface, the curved surface 22 is a cambered surface, and the connecting surface 23 is cylindrical.

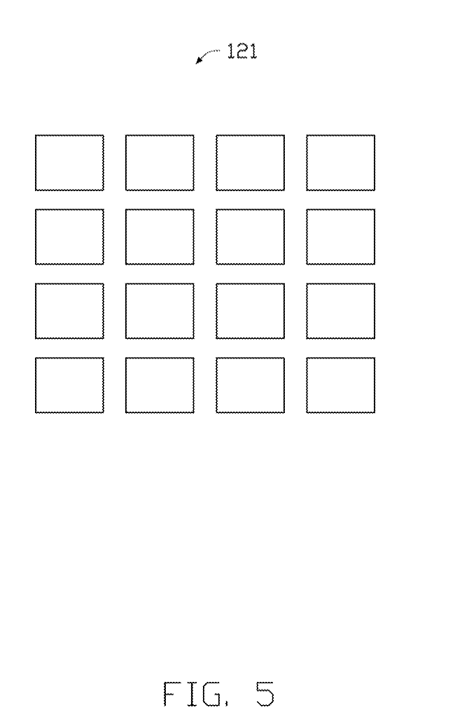

FIG. 5 illustrates that the back portion 12 defines a sensor array 121. The sensor array 121 senses a force on the back portion 12 when a user touches the back portion 12, converts the force to an electrical signal, and outputs the electrical signal.

In at least one embodiment, the hand portions 20 have six signal conducting poles 24. Each signal conducting pole 24 comprises a transverse portion 241 and a horizontal portion 242. The horizontal portion 242 is substantially perpendicular to the transverse portion 241. The six horizontal portions 242 are substantially perpendicular to each other and intersect with each other to form a rectangular Cartesian coordinate system. The six signal conducting poles 24 are substantially perpendicular to each other. One transverse portion 241 is mounted on a surface of the triaxial force sensor 25, the other transverse portions 241 are equidistantly mounted in the hand portion 20.

The triaxial force sensor 25 can sense a force in three dimensions (Fx, Fy, and Fz). The triaxial force sensor 25 receives the action signal from the signal conducting poles 24 and converts the signal to an electrical signal.

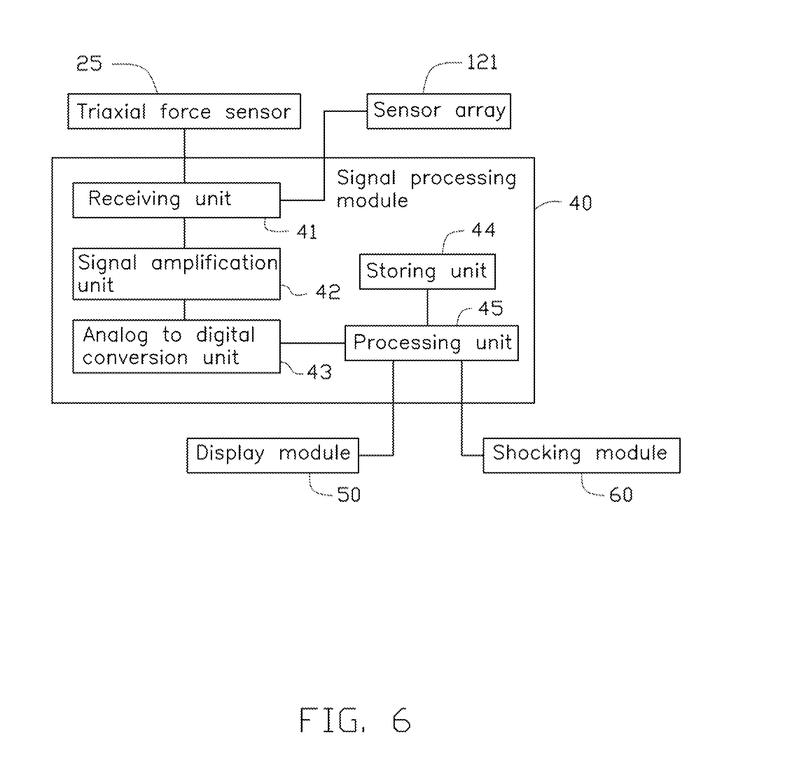

FIG. 6 illustrates that the interactive robot 100 comprises a signal processing module 40, a display module 50, and a shocking module 60. The signal processing module 40 comprises a receiving unit 41, a signal amplification unit 42, an analog-to-digital converter (ADC) unit 43, a storing unit 44, and a processing unit 45. The receiving unit 41 receives the electrical signal from triaxial force sensor 25 and the sensor array 121. The signal amplification unit 42 amplifies the electrical signal from the receiving unit 41. The ADC unit 43 converts the amplified electrical signal to data.

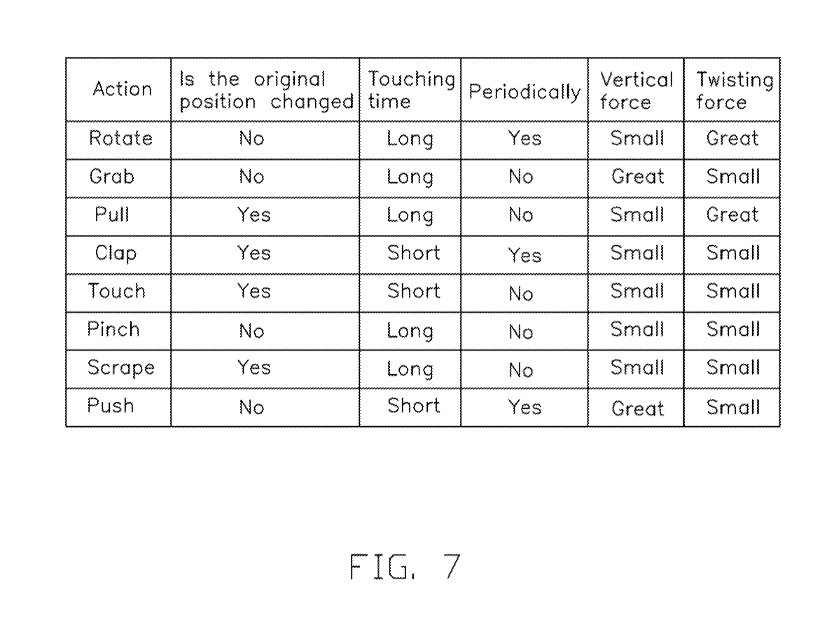

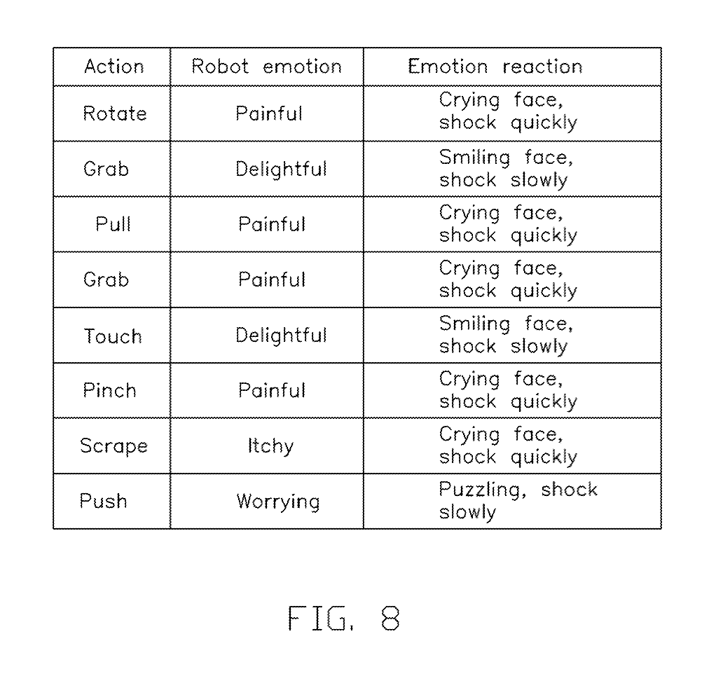

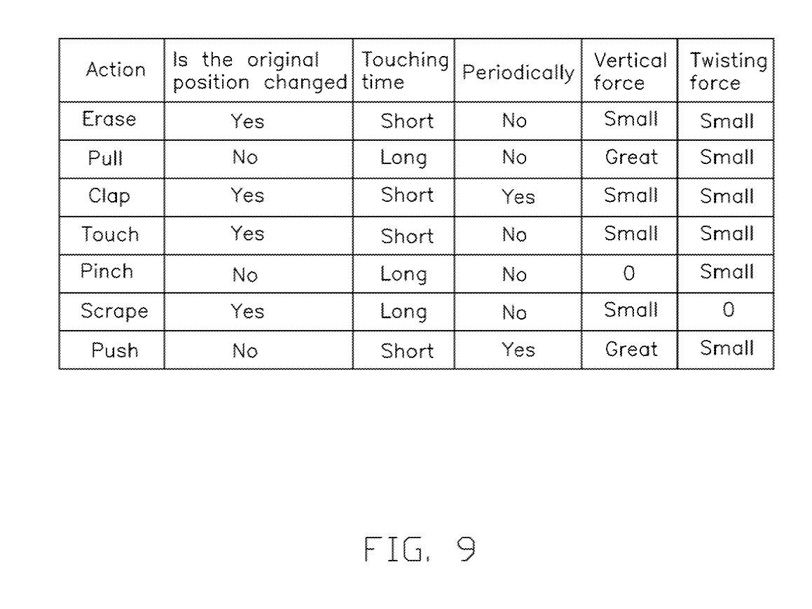

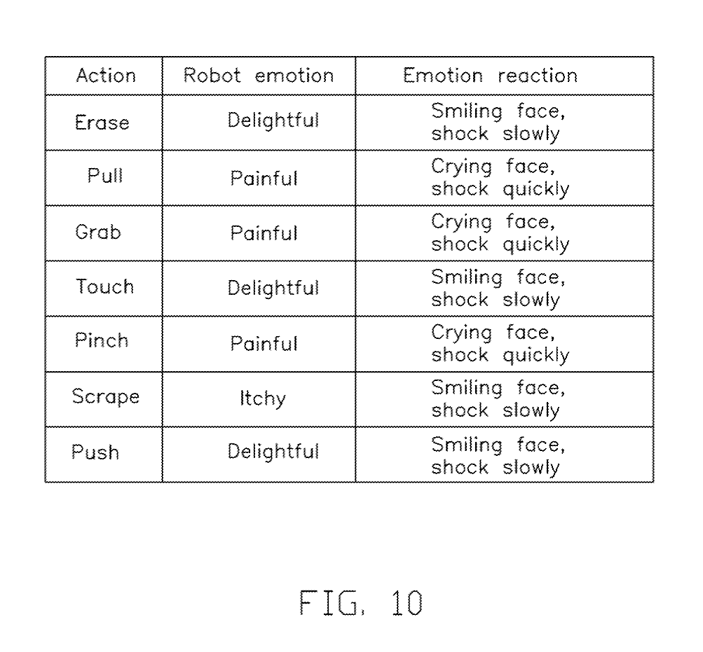

FIG. 7 illustrates that the storing unit 44 stores a plurality of actions in relation to the hand portion 20. FIG. 8 illustrates that the storing unit 44 stores a plurality of emotional reactions corresponding to human actions applied to the hand portion 20. FIG. 9 illustrates that the storing unit 44 stores a plurality of actions about the hand portions 20. FIG. 10 illustrates that the storing unit 44 stores a plurality of emotional reactions corresponding to the actions.

The processing unit 45 analyzes the data from the ADC unit 43, compares the characteristics of the data with the information stored in the storing unit 44 (shown in FIGS. 7-10), determines an action which has been applied to the hand portion 20 or to the back portion 12, determines an emotional reaction accordingly, and sends a reaction signal corresponding to the emotional reaction to the display module 50 and to the shocking module 60, thereby enabling the display module 50 and the shocking module 60 to demonstrate a response.

The display module 50 receives the reaction signal from the processing unit 45 and controls the display panel 111 to display a facial emotion. The shocking module 60 receives the reaction signal from the processing unit 45 and indicates shock at one frequency according to the reaction signal.

When an action is applied to the hand portion 20 by a user, the signal conducting poles 24 send action signals to the triaxial force sensor 25. The triaxial force sensor 25 converts the action signals to an electrical signal according to a mathematical function and sends the electrical signal to the signal processing module 40. The receiving unit 41 amplifies the electrical signal and sends the amplified electrical signal to the ADC unit 43. The ADC unit 43 converts the amplified electrical signal into data and sends the data to the processing unit 45. The processing unit 45 extracts content of the data, compares the content of the data with the information stored in the storing unit 44 (shown in FIGS. 7-10), determines the action which has been applied to the hand portion 20 or to the back portion 12, determines an emotional reaction suitable to the action, and sends a reaction signal corresponding to the emotional reaction to the display module 50 and the shocking module 60. The display module 50 controls the display panel 111 to display a particular countenance. The shocking module 60 shocks.

When an action is applied to the back portion 12 by the user, the sensor array 121 senses the applied action, converts the applied action to an electrical signal, and sends the electrical signal to the signal processing module 40. The receiving unit 41 amplifies the electrical signal and sends the amplified electrical signal to the ADC unit 43. The ADC unit 43 converts the amplified electrical signal to data and sends the data to the processing unit 45. The processing unit 45 extracts content of the data, compares the content of the data with the information stored in the storing unit 44 (shown in FIGS. 7-10), determines an action which has been applied to the hand portion 20 or to the back portion 12, determines an emotional reaction to correspond to the action, and sends a reaction signal corresponding to the emotional reaction to the display module 50 and the shocking module 60. The display module 50 controls the display panel 111 to display a particular countenance. The shocking module 60 shocks.

It is to be understood that even though numerous characteristics and advantages have been set forth in the foregoing description of embodiments, together with details of the structures and functions of the embodiments, the disclosure is illustrative only and changes may be made in detail, including in the matters of shape, size, and arrangement of parts within the principles of the disclosure to the full extent indicated by the broad general meaning of the terms in which the appended claims are expressed.

What is claimed is:

1. An interactive robot for mimicking a baby's reactions to physical touches by a human user, the interactive robot comprising:
a main portion having:
a signal processing module, and
a display module coupled to the signal processing module; and
a hand portion having:
a plurality of signal conducting poles, and
a triaxial force sensor coupled to the signal conducting poles;
wherein the hand portion is located at one side of the main portion;
wherein the signal conducting pole is configured to:
sense an action signal from the hand portion, and
send the action signal to the triaxial force sensor;
wherein the triaxial force sensor is configured to:
convert the action signal to an electrical signal, and
send the electrical signal to the signal processing module;
wherein the signal processing module is configured to:
determine an action to correspond to the electrical signal,
determine an emotional reaction to correspond to the action, and
send a reaction signal to the display module; and
wherein the display module is configured to display one corresponding countenance after receiving the reaction signal.

2. The interactive robot of claim 1, wherein the main portion further comprises a shocking module, the shocking module is configured to receive the reaction signal and shock.

3. The interactive robot of claim 1, wherein each signal conducting pole comprise a horizontal portion, the plurality of horizontal portions intersect each other.

4. The interactive robot of claim 3, wherein each signal conducting pole further comprise a transverse portion, one transverse portion is mounted on a surface of the triaxial force sensor, and the transverse portions are equidistantly mounted in the hand portions.

5. The interactive robot of claim 4, wherein the horizontal portion is substantially perpendicular to the transverse portion.

6. The interactive robot of claim 1, wherein each signal conducting pole is substantially T-shaped.

7. The interactive robot of claim 1, further comprising another hand portion, wherein the two hand portions are located at opposite sides of the main portion, the two hand portions comprise six signal conducting poles, and the six signal conducting poles are substantially perpendicular to each other.

8. The interactive robot of claim 7, wherein the triaxial force sensor is configured to sense a force from three dimensions.

9. The interactive robot of claim 1, wherein the main portion comprise a front portion and a back portion, the display panel is defined on the front portion, the back portion comprises a sensor array, and the sensor array is configured to sense a force on the back portion.

10. The interactive robot of claim 9, wherein the signal processing module comprises a signal amplification unit, an analog to digital conversion unit, and a processing unit, the signal amplification unit is configured to amplify the electrical signal, the analog to digital conversion unit is configured to convert the electrical signal to a data, and the processing unit is configured to extract a feature of the data, determine an action on the hand portions, determine an emotional reaction to correspond to the action, and send a reaction signal corresponding to the emotional reaction to the display module.

11. An interactive robot mimicking a baby's reactions to physical touches by a human user, the interactive robot comprising:
a main portion having:
a display panel,
a signal processing module, and
a display module coupled to the signal processing module and the display panel; and
two hand portions having:
a plurality of signal conducting poles, and
a triaxial force sensor signal conducting poles;
wherein the two hand portions are located at opposite sides of the main portion;
wherein the signal conducting pole is configured to:
sense an action signal from the hand portions, and
send the action signal to the triaxial force sensor;
wherein the triaxial force sensor is configured to
convert the action signal to an electrical signal, and
send the electrical signal to the signal processing module;
wherein the signal processing module is configured to:
determine an action to correspond to the electrical signal,
determine an emotional reaction to correspond to the action, and
send a reaction signal to the display module; and
wherein the display module is configured to control the display panel to display one corresponding countenance after receiving the reaction signal.

12. The interactive robot of claim 11, wherein the main portion further comprises a shocking module, the shocking module is configured to receive the reaction signal and shock.

13. The interactive robot of claim 11, wherein each signal conducting pole comprise a horizontal portion, the plurality of horizontal portions intersect each other.

14. The interactive robot of claim 13, wherein each signal conducting pole further comprise a transverse portion, one transverse portions is mounted on a surface of the triaxial force sensor, and the other transverse portions are equidistantly mounted in the hand portions.

15. The interactive robot of claim 11, wherein the hand portions comprise six signal conducting poles and the six signal conducting poles are substantially perpendicular to each other.

16. The interactive robot of claim 11, wherein the main portion comprise a front portion and a back portion, the display panel is defined on the front portion, the back portion comprises a sensor array, and the sensor array is configured to sense a force on the back portion.

17. The interactive robot of claim 16, wherein the signal processing module comprises a signal amplification unit and the signal amplification unit is configured to amplify the electrical signal.

18. The interactive robot of claim 17, wherein the signal processing module further comprises an analog to digital conversion unit and the analog to digital conversion unit is configured to convert the electrical signal to a data.

19. The interactive robot of claim 18, wherein the signal processing module further comprises a processing unit and the processing unit is configured to extract a feature of the data, determine an action on the hand portions, determine an emotional reaction to correspond to the action, and send a reaction signal corresponding to the emotional reaction to the display module.

20. The interactive robot of claim 19, wherein the signal processing module further comprises a storing unit, the storing unit stores a plurality of actions and emotional reactions.
